(19) United States
(12) Patent Application Publication
(10) Pub. No.: US 2014/0137221 A1
(43) Pub. Date: May 15, 2014

(54) IMAGE META DATA DRIVEN DEVICE AUTHENTICATION

(71) Applicant: INTERNATIONAL BUSINESS MACHINES CORPORATION, Armonk, NY (US)

(72) Inventors: Joel T. Dominic, Ruckersville, VA (US); Robert E. Loredo, North Miami Beach, FL (US); Adrian X. Rodriguez, Durham, NC (US); Felicia N. Soto, Raleigh, NC (US)

(73) Assignee: International Business Machines Corporation, Armonk, NY (US)

(21) Appl. No.: 13/676,556

(22) Filed: Nov. 14, 2012

(51) Int. Cl. H04L 29/06

(52) U.S. Cl. CPC H04L 63/08
USPC 726/7

(57) ABSTRACT

Embodiments of the present invention address deficiencies of the art in respect to image based authentication and provide a novel and non-obvious method, system and computer program product for image meta data driven device authentication. In an embodiment of the invention, a method for image meta data driven device authentication is provided. The method includes acquiring an image in a computing device on behalf of an end user and generating a set of keywords describing the image in image recognition logic coupled to the computing device. The method additionally includes comparing the set of keywords describing the image to keywords in a keyword list stored in connection with the end user. Finally, the method includes authenticating the end user if a threshold number of keywords in the set match keywords in the keyword list, but otherwise denying the end user access to the computing device.

### BACKGROUND OF THE INVENTION

1. Field of the Invention

The present invention relates to device authentication and more particularly to image based device authentication.

2. Description of the Related Art

Device authentication refers to the testing of an identity of an end user of a device to ensure proper authorization of the end user to access the device. Traditional methods of performing device authentication include general password authentication in which an end user submits in response to a prompt a predetermined password in order to gain access to the device. More advanced forms of password authentication involve the submission of any combination of a user identifier, private key or passphrase in addition to one or more answers to one or more corresponding challenge questions. Even more advanced modes of device authentication involve biometric analysis in which the finger print, voice print or iris scan of an end user can be compared to a pre-stored print in order to assure the authorized access of a submitting end user.

Imagery has been incorporated previously in the device authentication process. Specifically, an image can be pre-stored by an end user and, during authentication, the pre-stored image can be provided to the end user so that the end user can be assured that the authentication system is genuine and not spoofed. Likewise, imagery has been incorporated into an authentication process by comparing a pre-stored image to that acquired by a device camera. To the extent the imagery matches, access to the device can be granted. Of course, acquiring an image that precisely matches a pre-stored image is not without its apparent complications.

### BRIEF SUMMARY OF THE INVENTION

Embodiments of the present invention address deficiencies of the art in respect to image based authentication and provide a novel and non-obvious method, system and computer program product for image meta data driven device authentication. In an embodiment of the invention, a method for image meta data driven device authentication is provided. The method includes acquiring an image in a computing device on behalf of an end user and generating a set of keywords describing the image in image recognition logic coupled to the computing device. The method additionally includes comparing the set of keywords describing the image to keywords in a keyword list stored in connection with the end user. Finally, the method includes authenticating the end user if a threshold number of keywords in the set match keywords in the keyword list, but otherwise denying the end user access to the computing device.

In another embodiment of the invention, a computer data processing system can be configured for image meta data driven device authentication. The system can include a host computing device with memory and at least one processor and an image sensor coupled to the host computing device. The system also can include a data store of keyword lists each keyword list stored in connection with a different end user. Finally, the system can include an image meta data based authentication module executing in the memory of the host computing device. The module can include program code enabled to generate in image recognition logic a set of keywords describing an image acquired by the image sensor coupled to the computing device, to compare the set of keywords describing the image, to compare the set of keywords describing the image to keywords in a keyword list stored in the data store in connection with the end user, and to authenticate the end user if a threshold number of keywords in the set match keywords in the keyword list, but otherwise to deny the end user access to the computing device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for image meta data driven device authentication;

FIG. 2 is a schematic illustration of a data processing system configured for image meta data driven device authentication; and,

FIG. 3 is a flow chart illustrating a process for image meta data driven device authentication.

### DETAILED DESCRIPTION OF THE INVENTION

Embodiments of the invention provide for image meta data driven device authentication. In accordance with an embodiment of the invention, an image stored for a device in association with an authorized end user can be loaded and characterized textually according to the subject and context of the image. Keywords can be produced from the characterization and stored as a passphrase set for the end user. Thereafter, an end user seeking access to the device dynamically can provide an image and the dynamically provided image can be characterized textually according to the subject and context of the image to produce one or more keywords. Finally, the keywords produced for the dynamically provided image can be compared to those of the passphrase and to the extent a threshold match of keywords can be found, access to the device can be permitted.

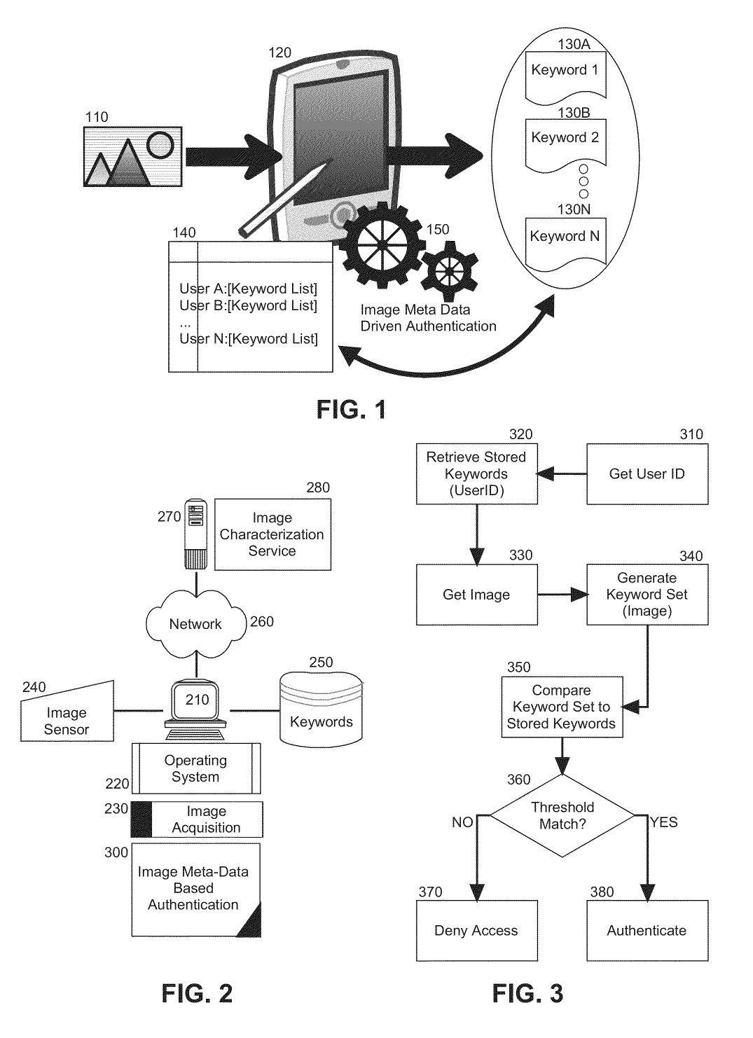

In further illustration, FIG. 1 pictorially shows a process for image meta data driven device authentication. As shown in FIG. 1, an image 110 can be acquired in a computing device 120. For instance, a camera provided in connection with the computing device 120 can acquire an image photographically, or the image can be drawn manually on a touch screen or using another pointing device provided in connection with the computing device 120. Image meta data authentication logic 150 can generate a set of keywords 130A, 130B, 130N representative of the content of the image 110 and optionally, the context of the content of the image 110. Thereafter, the image meta data authentication logic 150 can compare the keywords 130A, 130B, 130N with a keyword list for a specified end user disposed within a table of end user to keyword lists 140. To the extent a threshold number of the keywords 130A, 130B, 130N match those of the keyword list for the specified end user, the specified end user can be authenticated with respect to the computing device 120.

The process described in connection with FIG. 1 can be implemented within a computer data processing system. In yet further illustration, FIG. 2 schematically shows a computer data processing system configured for image meta data driven device authentication. The system can include a host computing device 210 such as a personal digital assistant, a smart phone, a personal computer, tablet personal computer, notebook or laptop computer and the like. The host computing device 210 can support the execution of an operating system 220 enabled to host the operation of computer readable program code. An image sensor 240 can be included with the host computing device 210 and configured to acquire imagery through image acquisition program code 230. In this regard, the image sensor 240 can be a camera, or a drawing application through which a drawing can be provided by an end user.

A data store of keyword lists 250 can be coupled to the host computing device 210. The data store of keyword lists 250 can include different lists of keywords associated with different end users. In particular, the different lists of keywords in the data store of keyword lists 250 can be generated in association with correspondingly different images acquired through the image acquisition program code 230. In this regard, for each acquired image, one or more keywords descriptive of the content of the content of the image or the context of the content of the image can be added to a corresponding keyword list and stored in the data store of keyword lists 250 in association with a particular end user. The keywords for each acquired image can be specified manually, or automatically by submitting the image to an image characterization service 280 providing an image recognition application executing in a server 270 over computer communications network, and receiving therefrom the keywords for the image.

Of note, an image meta data based authentication module 300 can execute through the operating system 220. The image meta data based authentication module 300 can include computer readable program code enabled to receive on behalf of an identified end user, an image submitted to authenticate the end user to use the host computing device 210. The computer readable program code further can be enabled to generate one or more keywords descriptive of the content or the context of the content of the submitted image. For instance, the image can be processed in an image recognition portion of the image acquisition program code 230, or the image can be processed remotely in the image characterization service 280. In either circumstance, the keywords generated for the submitted image can be compared to the keywords in a keyword list in the data store of keyword lists 250. To the extent that a threshold number of the generated keywords match those of the keyword lists for the identified end user, the identified end user can be authenticated to access the host computing device 210.

In even yet further illustration of the operation of the image meta data based authentication module 300, FIG. 3 is a flow chart illustrating a process for image meta data driven device authentication. Beginning in block 310, a user identification can be received for an end user seeking access to an end user device. In block 320, different keywords for the end user can be retrieved and in block 330 an image can be acquired from the identified end user. In block 340 a set of keywords can be generated for the acquired image. Thereafter, in block 350 the generated keywords can be compared to the different keywords retrieved for the identified end user. In decision block 360 it can be determined if a threshold number of the generated keywords match those of the different keywords retrieved for the identified end user. If not, access to the computing device for the end user can be denied in block 370. Otherwise, the identified end user can be permitted access to the computing device in block 380.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for image meta data driven device authentication, the method comprising:
acquiring an image in a computing device on behalf of an end user;
generating a set of keywords describing the image in image recognition logic coupled to the computing device;
comparing the set of keywords describing the image to keywords in a keyword list stored in connection with the end user; and,
authenticating the end user if a threshold number of keywords in the set match keywords in the keyword list, but otherwise denying the end user access to the computing device.

2. The method of claim 1, wherein the computing device is a smart phone.

3. The method of claim 1, wherein the computing device is a personal digital assistant.

4. The method of claim 1, wherein the computing device is a tablet computer.

5. The method of claim 1, wherein the image recognition logic executes in memory of a computer communicatively coupled to the computing device over a computer communications network.

6. The method of claim 1, wherein at least one of the keywords describe content of the image and at least one of the keywords describe a context of the content of the image.

7. The method of claim 1, wherein the image is acquired through a camera disposed in the computing device.

8. The method of claim 1, wherein the image is acquired through a drawing application executing in the computing device.

9. A computer data processing system configured for image meta data driven device authentication, the system comprising:
a host computing device with memory and at least one processor;
an image sensor coupled to the host computing device;
a data store of keyword lists each keyword list stored in connection with a different end user; and,
an image meta data based authentication module executing in the memory of the host computing device, the module comprising program code enabled to generate in image recognition logic a set of keywords describing an image acquired by the image sensor coupled to the computing device, to compare the set of keywords describing the image, to compare the set of keywords describing the image to keywords in a keyword list stored in the data store in connection with the end user, and to authenticate the end user if a threshold number of keywords in the set match keywords in the keyword list, but otherwise to deny the end user access to the computing device.

10. The system of claim 9, wherein the computing device is a smart phone.

11. The system of claim 9, wherein the computing device is a personal digital assistant.

12. The system of claim 9, wherein the computing device is a tablet computer.

13. The system of claim 9, wherein the image recognition logic executes in memory of a computer communicatively coupled to the host computing device over a computer communications network.

14. The system of claim 9, wherein at least one of the keywords describe content of the image and at least one of the keywords describe a context of the content of the image.

15. The system of claim 9, wherein the image sensor is a camera.

16. The system of claim 9, wherein the image sensor is a drawing application executing in the computing device.

17. A computer program product for image meta data driven device authentication, the computer program product comprising:
a computer readable storage medium having computer readable program code embodied therewith, the computer readable program code comprising:
computer readable program code for acquiring an image in a computing device on behalf of an end user;
computer readable program code for generating a set of keywords describing the image in image recognition logic coupled to the computing device;
computer readable program code for comparing the set of keywords describing the image to keywords in a keyword list stored in connection with the end user; and,
computer readable program code for authenticating the end user if a threshold number of keywords in the set match keywords in the keyword list, but otherwise denying the end user access to the computing device.

18. The computer program product of claim 17, wherein the computing device is a smart phone.

19. The computer program product of claim 17, wherein the computing device is a personal digital assistant.

20. The computer program product of claim 17, wherein the computing device is a tablet computer.

21. The computer program product of claim 17, wherein the image recognition logic executes in memory of a computer communicatively coupled to the computing device over a computer communications network.

22. The computer program product of claim 17, wherein at least one of the keywords describe content of the image and at least one of the keywords describe a context of the content of the image.

23. The computer program product of claim 17, wherein the image is acquired through a camera disposed in the computing device.

24. The computer program product of claim 17, wherein the image is acquired through a drawing application executing in the computing device.
